(19) United States
(12) Patent Application Publication
(10) Pub. No.: US 2012/0138386 A1
(43) Pub. Date: Jun. 7, 2012

(54) STRUCTURE, SAFETY APPARATUS AND KIT FOR SAFEGUARDING WORKERS LOCATED ATOP A CONTAINER

(75) Inventor: Marc ROBITAILLE, Quebec (CA)

(73) Assignee: SUPERMETAL STRUCTURES INC., St-Romuald (CA)

(21) Appl. No.: 12/960,907

(22) Filed: Dec. 6, 2010

(51) Int. Cl. A62B 35/00; E04G 5/14

(52) U.S. Cl. 182/3; 182/12

(57) ABSTRACT

The present disclosure relates to a structure, a safety apparatus and a kit for safeguarding workers located atop a freight vehicle. The structure comprises a base and a top rail supported by the base. The top rail is in overhanging placement relative to the base so that the vehicle may be positioned adjacent to the structure and underneath the top rail. Safety equipment may be attached to a moveable attachment point supported by the top rail so that workers may wear the safety equipment and walk along a length of the vehicle while being protected from an eventual fall.

### TECHNICAL FIELD

This present disclosure relates to the field of safety equipment, and more specifically, to a structure, a safety apparatus and a kit for safeguarding workers located atop a freight vehicle.

### BACKGROUND

Falls are one of the most prevalent causes of industrial accidents causing deaths and crippling injuries. Billions of dollars are spent or lost due to losses of lives, insurance payments, high insurance premiums, and the like.

Vehicles used for cargo transport are an important example of structures on which workers may need to climb, and possibly fall from. As an example, the transport industry relies heavily on containers, such as so-called multi-modal containers that may be conveniently be transported in ships, on trains or on flatbed trailers. Currently, hundreds of millions of containers are shipped worldwide on a yearly basis. Billions of dollars worth of merchandize are shipped worldwide on a daily basis. Given such numbers, rapid manipulation such as loading and unloading freight vehicles is an important economical requirement.

Fall protection equipment may permanently or semi-permanently be installed in factories or in construction sites, where the general environment does not change or only gradually changes. Because freight vehicles come on sites and are loaded or unloaded within hours before being shipped again, conventional permanent or semi-permanent installations are ill-suited for providing fall protection for workers having to climb and move about on top of such vehicles.

Therefore, there is a need for fall protection equipment being specifically adapted to support and protect workers needing to climb on freight vehicles while at the same time providing convenient access to move the freight vehicles in and out of a site.

### SUMMARY

Safety equipment such as fall protection systems require techniques that are especially tailored to the needs of the shipping industry.

The present disclosure provides a structure for safeguarding workers located atop a freight vehicle positioned along a base of the structure. The structure comprises a horizontal top rail supported by the base, in overhanging placement relative to the base, and the rail being adapted to receive at least one moveable attachment point for connecting to personal safety equipment.

The present disclosure also relates to a safety apparatus for safeguarding workers located atop a freight vehicle positioned along a base of the apparatus. The apparatus comprises a horizontal top rail supported by the base. The top rail is in overhanging placement relative to the base. At least one support link is connected to the top rail by a moveable attachment point. The support link is for use in supporting a worker in case of a fall.

In another aspect, the present disclosure provides a safety apparatus for safeguarding workers located atop a freight vehicle positioned along a base of the apparatus. The apparatus comprises a horizontal top rail supported by the base. The top rail is in overhanging placement relative to the base. At least one support link is connected to the top rail by a moveable attachment point. The support link is for use in attaching to personal safety equipment.

In a further aspect, the present disclosure provides a self-supporting safety structure assembly kit for safeguarding workers located atop a freight vehicle positioned along the safety structure. The kit comprises an elongated base, two upright members mountable on the base, a first side of a horizontal top frame mountable on the two upright members, two horizontal supports attachable to the first side of the horizontal top frame, and a horizontal top rail for forming a second side of the horizontal top frame. The horizontal top rail is attachable to the two horizontal supports. The horizontal top rail is adapted to receive at least one moveable attachment point for connecting to personal safety equipment. The base, the upright members, the first side of the horizontal top frame, the horizontal supports and the horizontal top rail are configured so that when the two upright members are mounted to the base, with the first side of the horizontal top frame mounted on the two upright members and with the horizontal top rail connected to the first side of the horizontal top frame through the two horizontal supports, the horizontal top rail is in overhanging placement relative to the base.

### BRIEF DESCRIPTION OF THE DRAWINGS

Embodiments of the disclosure will be described by way of example only with reference to the accompanying drawings, in which:

FIG. 1 is a perspective view of a structure according to an embodiment;

FIG. 2 is a front elevation view of the structure of FIG. 1, in use with workers, a flatbed trailer and a cargo;

FIG. 3 is a side elevation view of the structure of FIG. 1, in use with workers, a flatbed trailer and a cargo;

FIG. 4 is a detailed, side elevation view of a rail made part of the structure of FIG. 1; and

FIG. 5 is a detailed side view of a trolley assembled on a rail.

### DETAILED DESCRIPTION

A structure is provided for safeguarding workers located atop a freight vehicle positioned along a base of the structure. The structure may be self-supporting and may be installed permanently or semi-permanently on a site where cargo is carried, for example on top of flatbed trailer trucks. Alternatively, the structure may be installed on the side of a railroad track to safely support workers loading and unloading cargo transported on flatcar wagons. The structure may further be installed on a dock, for loading and unloading cargo transported on ships. The structure comprises a horizontal top rail supported by the base. The top rail is in overhanging placement relative to the base so that the rail is above a vehicle when parked adjacent to the base. At least one support link may be connected to the rail via a moveable attachment point, thereby forming movable personal safety equipment. Each support link is for use in supporting, in case of an eventual fall, a worker standing or kneeling on top of the vehicle or on top of the cargo. As the worker walks along a length of the vehicle or cargo, the vehicle being substantially parallel to the rail, the support link and its moveable attachment point move along the rail. In the event of a fall, the worker is maintained by the support link, thereby preventing possible injuries. The structure may be provided as a self-supporting safety structure assembly kit comprising the base, two or more upright members, a first side of a horizontal frame, the horizontal top rail forming a second side of the horizontal top frame, and two or more horizontal supports. Some elements of the kit may be pre-assembled. Final assembly of the kit elements at a work site arrives at the same structure as described hereinabove.

In the context of the present disclosure, the term “vehicle” is understood in a broad sense and may comprise various transportation means including, but not limited to, flatbed trucks, semi-trailers, and wagons including flatbed wagons, ships, barges, and the like. Of course, such transportation means may be loaded or unloaded, whether or not a motorized apparatus, such as a trailer truck or locomotive, is present at loading or unloading time. Therefore, the term “vehicle” is not limited to a self-propelling vehicle.

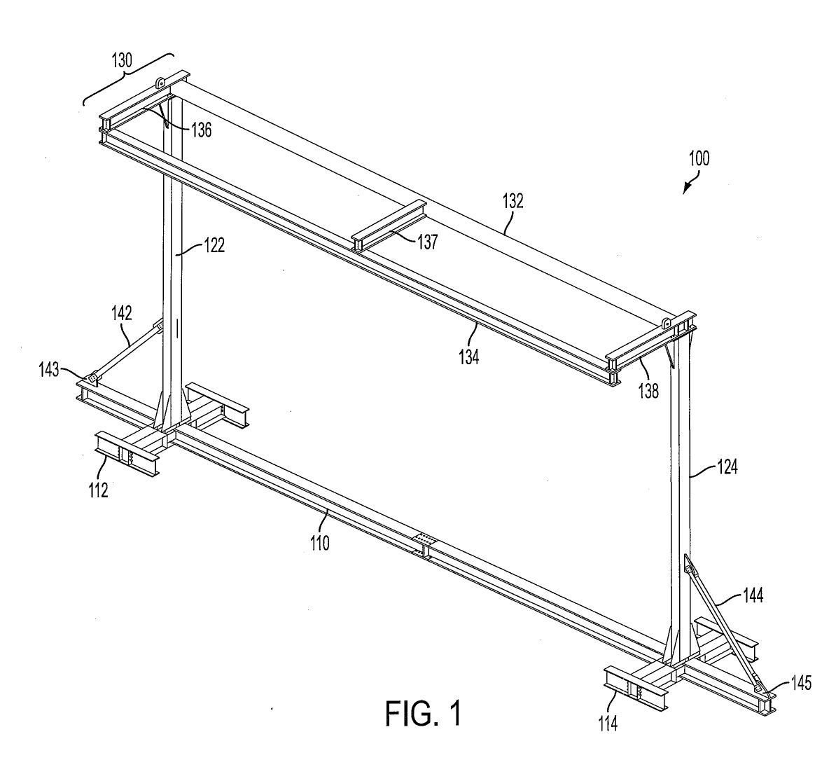

Referring to FIG. 1, there is shown a perspective view of an assembled structure according to an embodiment. The exemplary structure 100 of FIG. 1 comprises an elongated base 110, footings 112, 114 at or near each end of the base 110, two upright members 122, 124, a top frame 130, and lower braces 142, 144. The top frame 130 is horizontal and comprises a first side 132 located vertically above the base 110, a horizontal rail 134 forming a second side of the top frame 130, the rail 134 being in overhanging placement relative to the base 110, and three (3) horizontal supports 136, 137, 138, the horizontal rail 134 being connected to the first side 132 through the horizontal supports 136, 137, 138. The various components of the structure 100 may be formed of various steel alloys or similar materials and may be assembled using bolts and nuts, using rivets, using welding, or using any other conventional means as is well-known in the art. In an embodiment, several elements of the structure 100 may be made of wood.

On the exemplary embodiment of FIG. 1, the base 110 extends externally beyond the upright members 122, 124 and provides attachment points 143, 145 to the lower braces 142, 144. In an embodiment, the lower braces 142, 144 may be omitted and the base 110 need not extend beyond the upright members 122, 124. In another embodiment, the lower braces 142, 144 may be placed internally within a space formed by the base 110 and the upright members 122, 124, attachment points (not shown) being located on the base 110 between the upright members 122, 124. In this embodiment as well, the base 110 need not extend beyond the upright members 122, 124.

As shown on FIG. 1, the two upright members 122, 124 are vertical and perpendicular to the base 110 and to the top frame 130. As such, the base 110, the two upright members 122, 124 and the first side 132 of the exemplary embodiment form a rectangle. In an embodiment, at least one of the two upright members 122, 124 may be placed at a non-orthogonal angle from the base 110 and top frame 130. In this embodiment, the base 110, the two upright members 122, 124 and the first side 132 may thus form a trapezoid. Likewise, as shown on FIG. 1, the top frame 130 is rectangular and the first side 132 has a substantially equal length as the top rail 134. In an embodiment, the first side 132 and the top rail 134 may have unequal length, in which case at least one of the horizontal supports 136, 138 may be placed at a non-orthogonal angle relative to the first side 132 and rail 134. In this embodiment, the top frame 130 may also form a trapezoid. Such variations may allow a builder of the structure 100 to provide at least a length of the rail 134 that is suitable for accommodating various cargo lengths, for example typical container lengths, such as 20-feet containers or 40-feet containers or 53-feet semi-trailers, in areas where a different distance between the upright members 122, 124 is more appropriate, due for example to space constraints.

Those of ordinary skill in the art will appreciate that the exemplary structure 100 of FIG. 1 is self-supporting, especially when counter-weights (shown on later figures) are placed on top of the footings 112, 114. This capability allows installing, dismounting, and moving the structure 100, or the kit, making it a semi-permanent installation. In an application where the structure 100 may be permanently installed, an alternate base may consist of any suitable ground or in-ground structure capable of supporting the weight of the upright members, top frame and workers. For example, the upright members 122, 124 may be anchored in a concrete floor. In an embodiment, a width of this base may be hidden under the ground, allowing a reduction of a lateral distance between a vehicle positioned next to the structure 100 and the upright members 122, 124 and also allowing a reduction an overhanging distance of the top rail 134 relative to this base.

In various embodiments of the kit, some of the elements of the structure 100 may be pre-assembled. In an embodiment, the base 110 may be pre-assembled with the footings 112, 114. In another embodiment, the complete horizontal frame 130 may be pre-assembled. As those of ordinary skills in the art can appreciate, various constraints may apply, such as for example maximum size and weight of components of the kit for handling and shipping purposes, or safety constraints related to a fail-safe assembly of the structure 100 from the kit. Manners of assembling the various kit components may comprise welding, or use of mechanical attachments such as bolts and nuts.

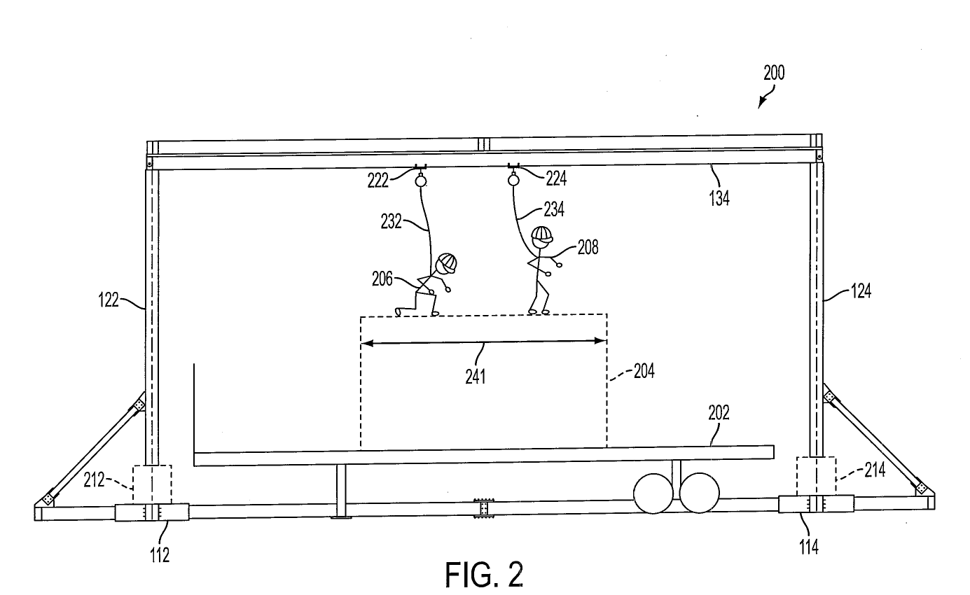

Referring now to FIG. 2, there is shown a front elevation view of the structure of FIG. 1, in use with workers, a flatbed trailer and a cargo. The structure 100 is shown in context, wherein a worksite 200 comprises a flatbed trailer 202, a cargo 204, and two workers 206, 208. Also shown are counter-weights 212, 214 placed on the footings 112, 114 and moveable attachment points 222, 224 on the rail 134. In an embodiment, the moveable attachment points may be rolling devices such as trolleys. In another embodiment, the moveable attachment points may be sliding devices such as sliding rails. Personal safety equipment comprises support links 232, 234 safely linking the workers 206, 208 to the moveable attachment points 222, 224. The support links 232, 234 may for example consist of chains, cables, ropes, wires or straps, provided with hooks for connecting to the moveable attachment points and to safety devices worn by the workers 206, 208. The personal safety equipment may further comprise safety harnesses or safety belts (not shown) worn by the workers 206, 208 and attached to the support links 232, 234. The flatbed trailer 202 may be substituted by a flatcar wagon (not shown) when the structure 100 is installed on the side of a railroad track.

A length of the rail 134 may accommodate typical container lengths, for example 20-feet containers and 40-feet containers, or a typical 53-feet trailer length. Of course, the length of the rail 134 may be tailored for other, non-standard applications. The workers 206, 208 may move along a length 241 of the cargo 204, as their movement pulls on the support links 232, 234, acting upon the moveable attachment points 222, 224 to move along the length of the rail 134.

A length of the support links 232, 234 is sufficient to allow the workers 206, 208 to stand or kneel on top of the cargo 204, along its width, the width of the cargo being perpendicular to the rail 134. At the same time, the length of the support links 232, 234 is sufficiently short so that, in the event of a fall, the workers 206, 208 will not fall down to the top of the flatbed trailer 202. In an embodiment, the support links 232, 234 may have an adjustable length. In another embodiment, the support links 232, 234 may be self-retracting so that a light pull may extend their length while a rapid pull will block any further extension. Embodiments in which the support links 232, 234 are adjustable or self-retracting allow the workers 206, 208 to safety move between the top of the cargo 204 and the top of the flatbed trailer 202.

FIG. 3 shows a side elevation view of the structure of FIG. 1, in use with workers, a flatbed trailer and a cargo. It may be observed on this view that counter-weights may be placed on top of the footings 112, 114, on both sides. For example, counter-weights 214, 215 are placed on top of the footing 114. This view also shows that an overhanging distance A between the rail 134 and the first side 132 (corresponding to a length of the horizontal supports 136, 137, 138, accounting for widths of the first side 132 and of the rail 134), exceeds a half-width B of the footings 112, 114 so that the rail 134 is in overhanging placement relative to the base as whole, the base including the footings. Of course, in an embodiment wherein the base 110 is anchored in the ground, using anchoring means that are placed under the ground, the overhanging length A may be shorter and the cargo 204 may be placed laterally closer to the structure 100. Regardless, the overhanging length A is determined such the cargo 204 may be positioned under the rail 134 so that the rail 134 is within a width 242 of the cargo 204.

Construction of the structure 100 may be further solidified by the addition of braces to the upright members 122 and 124. On FIG. 3, top braces 302, 304 are made part of the upright member 124, at its top. The top braces 302, 304 are diametrically opposed to each other and are perpendicular to the first side 132. The top braces 302, 304 provide additional support to the top frame 130. FIG. 3 also shows bottom braces 306, 308 at the bottom of the upright member 124. The bottom braces 306 and 308 are also diametrically opposed to each other, and perpendicular to the base 110. The bottom braces 306, 308 rest on top of the footing 114, providing additional support to the upright member 124. Of course, braces may also be present at the top and bottom of the upright member 122.

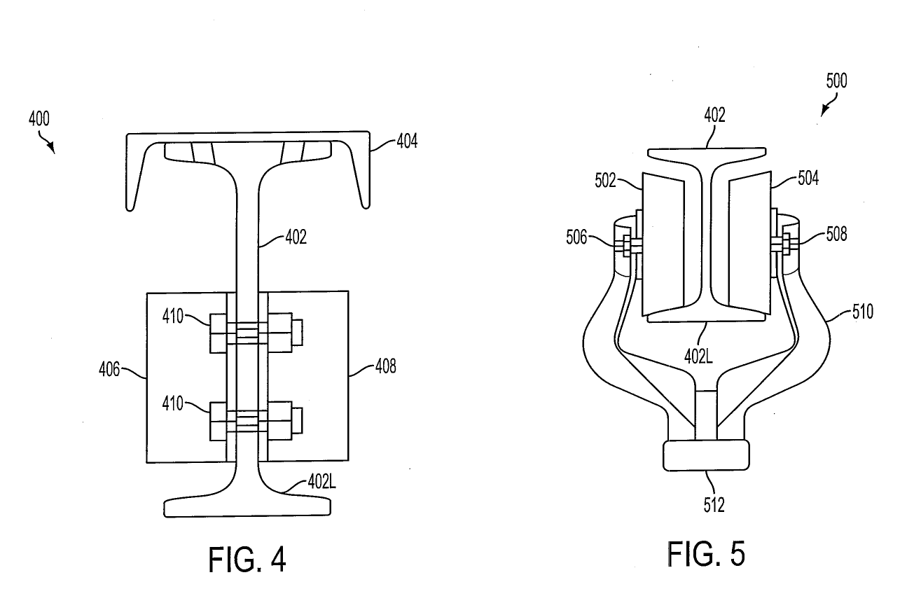

Referring to FIG. 4, there is shown a detailed, side elevation view of a rail made part of the structure of FIG. 1. An exemplary rail 400 is symmetric along its length and along its width and, as shown, may represent a view from its left or from its right hand side. The exemplary rail 400 comprises a H-beam 402, a U-beam 404, arrest plates 406, 408, and bolts 410. The H-beam 402 comprises a lower end 402L on which a moveable attachment point, for example a trolley (not shown), may freely move along a length of the rail 400. At each end of the rail 400, arrest plates 406, 408 are secured using bolts 410 in order to provide a stop preventing the moveable attachment point from becoming disengaged from the rail 400 at its extremities. The U-beam 404 is wide and shallow, and is affixed on top of the H-beam 402. Referring back to FIG. 1 wherein the rail 400 may form the top rail 134, the U-beam 404 may be affixed to the H-beam 402 using bolts that also support the complete rail 400 to the horizontal supports 136, 137, 138.

Referring to FIG. 5, there is shown a detailed side view of a trolley mounted on a rail. An exemplary trolley 500 is mounted for rolling on the lower end 402L of the H-beam-402. The trolley 500 comprises wheels 502, 504 attached to a body 510 via axles 506, 508. At the bottom of the body 510 is an attachment point 512 for a support link (not shown).

Those of ordinary skill in the art will realize that the foregoing description of the structure and safety apparatus are illustrative only and are not intended to be in any way limiting. Other embodiments will readily suggest themselves to such skilled persons having the benefit of this disclosure. Furthermore, the disclosed structure and safety apparatus can be customized to offer valuable solutions to existing needs and problems related to the prevention of accidents at freight vehicles loading and unloading sites.

In the interest of clarity, not all of the routine features of the implementations of the structure and safety apparatus are shown and described. It will, of course, be appreciated that in the development of any such actual implementation of the safety equipment, numerous implementation-specific decisions must be made in order to achieve the developer's specific goals, such as compliance with safety regulations and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of safety equipment having the benefit of this disclosure. Routine engineering may for example be required for properly selecting types of materials and gauges of the various components of the structure 100. In accordance with this disclosure, the components and structure described herein may be implemented using various types of materials and assembly procedures.

Although the present disclosure has been described hereinabove by way of non-restrictive illustrative embodiments thereof, these embodiments can be modified at will within the scope of the appended claims without departing from the spirit and nature of the present disclosure.

What is claimed is:

1. A structure for safeguarding workers located atop a freight vehicle positioned along a base of the structure, comprising:
a horizontal top rail supported by the base, in overhanging placement relative to the base, the rail being adapted to receive at least one moveable attachment point for connecting to personal safety equipment.

2. The structure of claim 1, further comprising two upright members extending between the base and a first side of a horizontal top frame, the top rail forming a second side of the horizontal top frame.

3. The structure of claim 2, wherein the two upright members are vertical members, the two vertical members, the base and the first side of the horizontal top frame forming a rectangle.

4. The structure of claim 1, wherein the base comprises at each end a footing extending on both sides of the base.

5. The structure of claim 4, wherein the overhanging placement of the horizontal top rail extends beyond the footing on the same side of the base.

6. The structure of claim 1, further comprising a stop at each end of the top rail for preventing the moveable attachment point from becoming disengaged from the top rail.

7. The structure of claim 1, wherein the moveable attachment point is free to move on the top rail along a length of a standard sized semi-trailer.

8. A safety apparatus for safeguarding workers located atop a freight vehicle positioned along a base of the apparatus, comprising:
a horizontal top rail supported by the base, in overhanging placement relative to the base;
at least one support link connected to the top rail by a moveable attachment point, wherein the support link is for use in supporting a worker in case of a fall.

9. The safety apparatus of claim 8, wherein the at least one support link is sufficiently long to allow the worker to stand or kneel along a width of the vehicle and sufficiently short to prevent the worker from falling below the top of the vehicle.

10. The safety apparatus of claim 8, wherein the at least one support link is self-retracting.

11. The safety apparatus of claim 8, wherein the moveable attachment point is a rolling device or a sliding device.

12. A self-supporting safety structure assembly kit for safeguarding workers located atop a freight vehicle positioned along the safety structure, comprising:
an elongated base;
two upright members mountable on the base;
a first side of a horizontal top frame mountable on the two upright members;
two horizontal supports attachable to the first side of the horizontal top frame; and
a horizontal top rail for forming a second side of the horizontal top frame, the horizontal top rail being attachable to the two horizontal supports and adapted to receive at least one moveable attachment point for connecting to personal safety equipment;
whereby the base, the upright members, the first side of the horizontal top frame, the horizontal supports and the horizontal top rail are configured so that when the two upright members are mounted to the base, with the first side of the horizontal top frame mounted on the two upright members and with the horizontal top rail connected to the first side of the horizontal top frame through the two horizontal supports, the horizontal top rail is in overhanging placement relative to the base.

13. The self-supporting safety structure assembly kit of claim 12, further comprising the at least one moveable attachment point.

14. The self-supporting safety structure assembly kit of claim 12, further comprising at least one support link for attachment to the at least one moveable attachment point.
